(19) United States
(12) Patent Application Publication
(10) Pub. No.: US 2010/0136511 A1
(43) Pub. Date: Jun. 3, 2010

(54) System and Method for Teaching a Musical Instrument

(76) Inventor: Aaron Garner, Rye, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/620,165

(22) Filed: Nov. 17, 2009

Related U.S. Application Data
(60) Provisional application No. 61/199,712, filed on Nov. 19, 2008.

(51) Int. Cl. G09B 5/00; G09B 7/00

(52) U.S. Cl. 434/307 R; 434/362

(57) ABSTRACT

A system for teaching a musical instrument includes an electronic keyboard. A computer is in communication with the electronic keyboard. A lessons and tracking server communicates over a network to the computer. The lessons and tracking server has a lessons module that serves up a lesson to the computer. The computer scores a student's performance and transmits a score to the lessons and tracking server.

An associated method of providing instruction for a musical instrument includes the steps of connecting an electronic instrument to a computer. A user logs into a musical instruction web site with the computer. A lesson is selected from a pedagogical series of lessons. A portion of the lesson is played and scored.

### RELATED APPLICATIONS

The present invention claims priority on provisional patent application, Ser. No. 61/199,712, filed on Nov. 19, 2008, entitled “Piano Marvel” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Learning to play a musical instrument has been shown to be an important part of a child's intellectual development. The most common method of musical instruction involves a teacher assigning pieces for the student to practice. Sometime later the student has a lesson with the teacher where the teacher grades the student's performance and provides tips on the areas where the student needs additional work. This method of instruction has not changed in hundreds of years. There have been attempts to create software that automatically grades a student's performance as they are playing a piece of music. Unfortunately, previous software does not provide a pedagogical series of lessons that the student can perform at their own pace. In addition, none of the previous systems work with electronic instruments. Today's students are use to playing video games and respond to game type environments.

Thus there exists a need for a system that instructs a student on how to play a musical instrument that has a pedagogical series of lessons and captures the student's attention.

### BRIEF SUMMARY OF INVENTION

A system for teaching a musical instrument that overcomes these and other problems includes an electronic keyboard. A computer is in communication with the electronic keyboard. A lessons and tracking server communicates over a network to the computer. The lessons and tracking server has a lessons module that serves up a lesson to the computer. The computer scores a student's performance and transmits a score to the lessons and tracking server.

An associated method of providing instruction for a musical instrument includes the steps of connecting an electronic instrument to a computer. A user logs into a musical instruction web site with the computer. A lesson is selected from a pedagogical series of lessons. A portion of the lesson is played and scored.

This system and method provides the user with a pedagogical series of lessons. The invention includes a trophy case showing how the user has performed on each lesson. This provides the same sort of reward feedback found in many computer games and keeps the student engaged and stimulates their competitive spirit.

### BRIEF DESCRIPTION OF THE SEVERAL VIEWS OF THE DRAWINGS

FIG. 1 is a block diagram of a system for teaching a musical instrument in accordance with on embodiment of the invention;

FIG. 2 is an example of the trophy case and score of student screen in accordance with one embodiment of the invention;

FIG. 3 is a flow chart of the step used in a method of providing instruction for a musical instrument in accordance with one embodiment of the invention; and

FIG. 4 is a flow chart of the step used in a method of providing instruction for a musical instrument in accordance with one embodiment of the invention.

### DETAILED DESCRIPTION OF THE INVENTION

The invention is a system and method that provides the user with a pedagogical series of lessons. The system includes a trophy case showing how the user has performed on each lesson. This provides the same sort of reward feedback found in many computer games and keeps the student engaged and stimulates their competitive spirit.

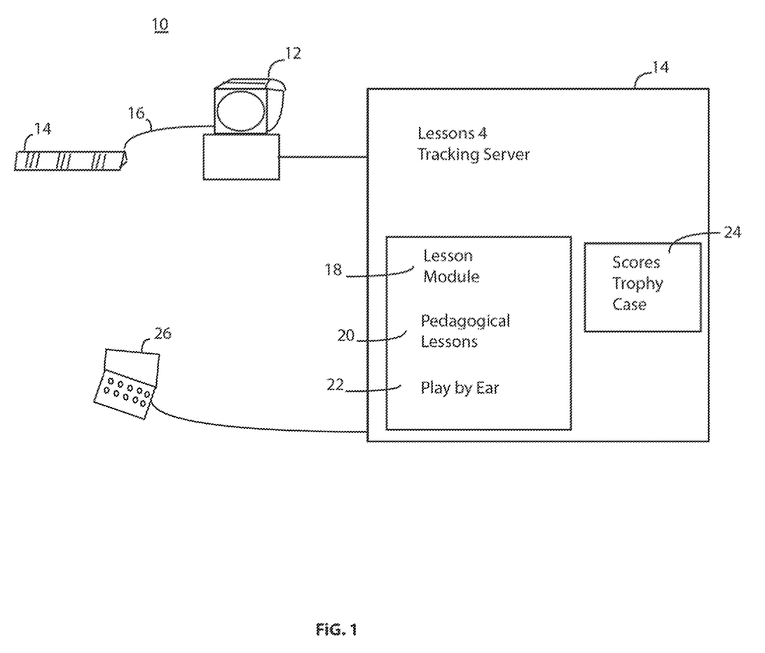

FIG. 1 is a block diagram of a system 10 for teaching a musical instrument in accordance with on embodiment of the invention. The system 10 includes a computer 12 that is connected to an electronic musical instrument 14. In one embodiment, the musical instrument is an electronic keyboard or electronic piano. The keyboard or piano may use a MIDI (Musical Instrument Digital Interface) interface 16 to communicate with the computer 12. The computer 12 is connected to a lessons and tracking server 14. In one embodiment, the lessons and tracking server is connected to the computer 12 through the internet. The lessons and tracking server include a lessons module 18. The lessons module 18 includes a book of pedagogical lesson 20 and play by ear lessons 22. The lessons and tracking server 14 also includes a scoring and tracking module 24. The scoring and tracking module 24 scores a student's performance on a lesson based on hitting the correct note at the correct time. In one embodiment, the system will show an incorrect note by displaying a red note next to the correct note on the score. If an incorrect key is hit, this is displayed as a red note that was actually played and if the timing was incorrect a red note is displayed at the time the key was actually hit. Correctly played notes may be shown in green. The scoring and tracking module also includes a trophy case that shows a student's progress in working through the pedagogical group of lessons. In one embodiment, the student is not able to play a higher level of lessons until they have a passing score on all the lessons at the present level. When a student plays a lesson successfully they may receive a bronze, silver, or gold trophy in their trophy case for the lesson. It has been found that this motivates the student to go back to lessons that they received a bronze or silver trophy and improve their score.

In one embodiment, the student's teacher, parents, or guardian can log onto the lessons and tracking server 14 and review the student's progress using a computer 26. They can view the student's trophy case, the amount of time that the student practiced on any given day, and what lessons the student worked on. Alternatively, the practice reports can be email to the teacher or the parents. In addition, the teacher can email (transmit) comments and instructions as part of the system to the student.

The system 10 is able to distinguish between the time the student practiced and the time they spent logged into the system, so a student cannot just log into the system for one half an hour, they must actually have been practicing. In one embodiment, this is accomplished by measuring the time between played notes. If the time between played notes exceeds a threshold, then the system 10 stops a practice counter until another note is played. The teacher's computer 26 may be connected to the lessons and tracking server 14 through the internet.

In one embodiment, the electronic instrument 14 may be an electronic guitar, or electronic drum set, or other electronic musical instrument.

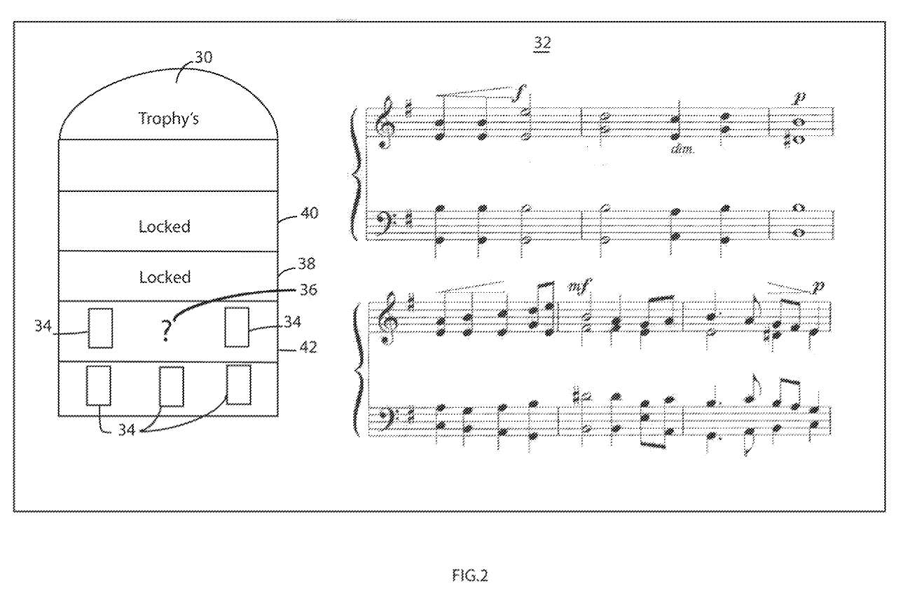

FIG. 2 is an example of the trophy case 30 and musical score 32 of student screen in accordance with one embodiment of the invention. When a student is playing a lesson his computer screen will show the trophy case 30 and a musical score 32. The trophy case 30 shows trophies 34 for completed lessons and a question mark 36 for a lesson that the student has not successfully completed. In addition, certain levels 38, 40 of the lessons may be locked until the student successfully completes the present level 42. This provides the student with a video game experience that drives them to excel.

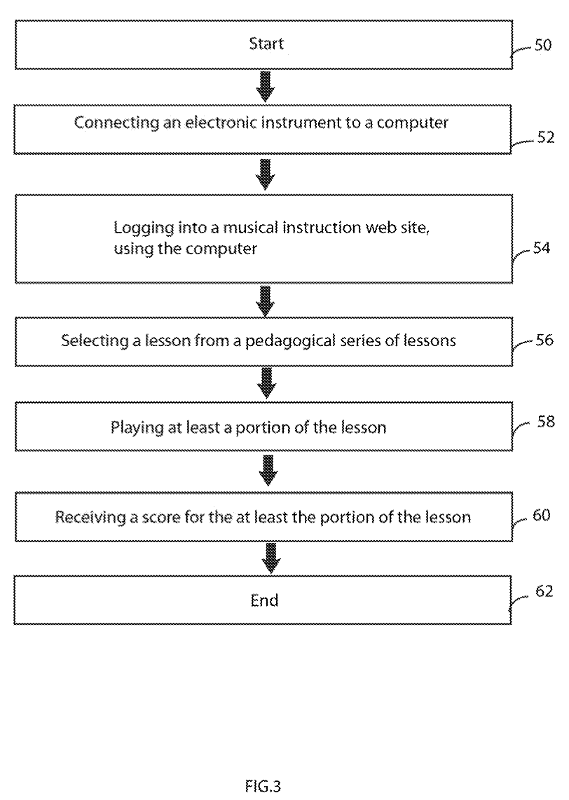

FIG. 3 is a flow chart of the steps used in a method of providing instruction for a musical instrument in accordance with one embodiment of the invention. The process starts, step 50, by connecting an electronic musical instrument to a computer at step 52. The student next logs into a musical instruction web site with their computer at step 54. A lesson is selected from a pedagogical series of lessons at step 56. At least a portion of the lesson is then played at step 58. At step 60, a score is received for the portion of the lesson played, which ends the process at step 62. Note that the system allows a student to work on sections of the song. For instance, if a student wants to learn a piece a teacher will typically assign the student the first 8 measures for the week and listen to that the next week. Then they will move on the the next section the following week and so on until the piece is finished. The repertoire library allows the teacher to split up a song into teaching sections so a student can get a score on just that section. It also allows the teacher to assess them at different tempos so they can get a score/trophy for the first 8 measures at a slow tempo and then they can get a score/trophy at a faster tempo and so on until it is up to speed. In one embodiment, the teacher can even have the student do hands separately in this manner. A memory section works in a similar manner in that the teacher can make the notes invisible and force the student to get the score without seeing what is written and this can be split up into sections as well. This allows the student to work on passages that are giving them particular problems and breaks down complex lessons into smaller sections. In one embodiment, the student can select a play be ear lesson.

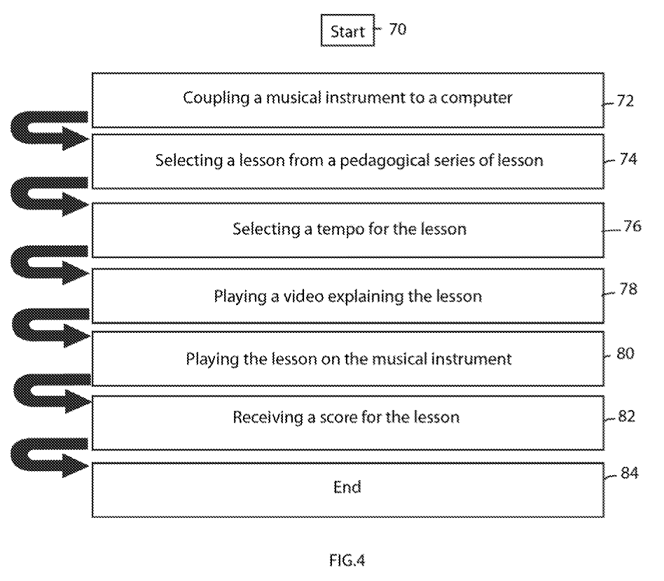

FIG. 4 is a flow chart of the steps used in a method of providing instruction for a musical instrument in accordance with one embodiment of the invention. The process starts, step 70, by coupling a musical instrument to a computer at step 72. A lesson is selected from a pedagogical series of lessons at step 74. A tempo is selected for the lesson at step 76. A video explaining the lesson is played on the computer at step 78. The lesson is played at step 80. At step 82, a score is received for the lesson, which ends the process at step 84. In one embodiment, the score is compared against a threshold to determine if the student received a passing score. In one embodiment, the lesson is a play by ear lesson. In another embodiment, the step of selecting the lesson includes the step of selecting a musical score lesson.

In one embodiment, an administrator can receive a request to add a musical piece to the lessons library. The administrator can upload that piece in minutes to the lessons server and every user in the world then has access to that piece within seconds without having to download new software. If there is a fingering mistake, the administrator can change that and it is changed for every user instantly.

In one embodiment, students who have passed all the lessons to a predetermined point are invited to participate in a competition. The students are paired off in a tournament. Two students compete over the internet for the highest score on piece. The winner then moves on to the next level in the tournament.

In one embodiment, copyrighted musical pieces are stored at the lessons and tracking server. The student can purchase one or more of these copyrighted musical pieces and then it becomes unlocked. This allows the student to practice the piece. The copyrighted musical pieces may appear in a store at the lesson server.

In another embodiment, the student's scores are exportable to grade reports so teachers in school systems using the software can upload the students' grades from the lessons server to their grade book software. In one embodiment, the system is setup as a service. As a result, the student does not have to buy the software and any upgrades are part of the basic subscription price. This cloud computing model is much more convenient for the student and their parents.

Thus, there has been describe a system and method of musical instruction that provides the user with a pedagogical series of lessons. The system includes a trophy case showing how the user has performed on each lesson. This provides the same sort of reward feedback found in many computer games and keeps the student engaged and stimulates their competitive spirit.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for teaching a musical instrument comprising:
an electronic musical instrument;
a computer in communication with the electronic musical instrument;
a lessons and tracking server communicating over a network to the computer, the lessons and tracking server having a lessons module having a group of pedagogical lessons, that serves up a lesson to the computer, the computer scoring a student's performance and transmitting a score to the lessons and tracking server.

2. The system of claim 1, wherein the electronic musical instrument is an electronic keyboard.

3. The system of claim 1, wherein the electronic musical instrument is an electronic guitar.

4. The system of claim 1, wherein the electronic musical instrument is an electronic drum.

5. The system of claim 1, wherein the lessons module includes a pedagogical series of lessons.

6. The system of claim 1, wherein the lessons module includes a play by ear group of lessons.

7. The system of claim 1, wherein the score is determined based on timing and correct note.

8. A method of providing instruction for a musical instrument comprising the steps of:
connecting an electronic instrument to a computer;
logging into a musical instruction web site, using the computer;
selecting a lesson from a pedagogical series of lessons;
playing at least a portion of the lesson; and
receiving a score for the at least the portion of the lesson.

9. The method of claim 8, further including the steps of:
when a complete lesson has been played, receiving a lesson score;
when the lesson score is above a threshold receiving a trophy for a student's trophy case.

10. The method of claim 9, further including the steps of:
when the lesson score is at or above a first threshold receiving a gold trophy;
when the lesson score is at or above a second threshold and below or a first threshold receiving silver trophy.

11. The method of claim 8, wherein the step of selecting the lesson includes the step of selecting a musical score lesson.

12. The method of claim 8, wherein the step of selecting the lesson includes the step of selecting a play by ear lesson.

13. The method of claim 8, further wherein the step of selecting the lesson includes the step of step of selecting a tempo.

14. The method of claim 8, wherein the step of selecting the lesson includes the step of selecting a memorizing mode.

15. A method of providing instruction for a musical instrument comprising the steps of:
coupling a musical instrument to a computer;
selecting a lesson from a pedagogical series of lessons;
selecting a tempo for the lesson;
playing a video explaining the lesson;
playing the lesson on the musical instrument; and
receiving a score for the lesson.

16. The method of claim 15, wherein the step of selecting a lesson includes the step of logging into a musical web site.

17. The method of claim 15, further including the step of:
determining if the score is above a threshold;
when the score is above the threshold, recording a pass for the lesson.

18. The method of claim 15, further including the steps of:
receiving a request to add a new musical score at the lessons and tracking server;
uploading the new musical score to the lesson module, whereby the new musical score is available throughout the world.

19. The method of 15, wherein the step of selecting a lesson includes the step of selecting a play be ear lesson.

20. The method of 15, wherein the step of selecting a lesson includes the step of selecting a musical score lesson.
